(19) United States
(12) Patent Application Publication
(10) Pub. No.: US 2013/0097794 A1
(43) Pub. Date: Apr. 25, 2013

(54) Portable Gun Cleaning System

(71) Applicant: REVO BRAND GROUP, LLC, PLYMOUTH, MN (US)

(72) Inventors: Barry David Brown, Shorewood, MN (US); Howard R. Tripp, Plymouth, MN (US)

(73) Assignee: REVO BRAND GROUP, LLC, PLYMOUTH, MN (US)

(21) Appl. No.: 13/656,196

(22) Filed: Oct. 19, 2012

Related U.S. Application Data
(60) Provisional application No. 61/548,889, filed on Oct. 19, 2011.

(51) Int. Cl. B25G 1/00

(52) U.S. Cl. 15/143.1

(57) ABSTRACT

The disclosed portable gun cleaning system is comprised of multiple components, including a variety of gun cleaning implements. These components can be combined to create gun cleaning kits used to clean a wide variety of types and sizes of guns. The system includes a t-handle, a flexible cable for improved portability, individual cleaning implements and quick connect couplings to attach the cleaning implements and the t-handle to the flexible cable. After a cleaning implement is attached to the flexible cable with a quick connect coupling, the cable is fed through the breech of a gun and the t-handle is attached to the opposite end of the flexible cable with a quick connect coupling. The cleaning implement is then pulled through the barrel of the gun. The t-handle is then removed using the quick connect coupling and the process is repeated.

### CROSS-REFERENCE TO RELATED APPLICATIONS

This application claims the benefit of U.S. Provisional Application Ser. No. 61/548,889, titled PORTABLE GUN CLEANING SYSTEM, filed Oct. 19, 2011.

### BACKGROUND OF THE INVENTION

The present disclosure relates to a portable gun cleaning system. The system herein includes compact field kits that allow users to clean their guns faster, easier and more effectively than the existing products in the marketplace.

Prior gun cleaning systems rely on attaching cleaning implements to a rod or flex cable by threading them together (screwing a male threaded coupling into a female threaded receiver). The handle is also attached using a threaded coupling. The system disclosed herein uses a quick connect coupling to attach a flexible cable to a t-handle on one end and a cleaning implement (brush, mop, jag, etc.) on the other end. The quick connect is much faster than the threaded coupling. Instead of screwing components together, a user simply snaps them together. Instead of unscrewing components apart from each other, the user presses a release and pulls them apart. Since components are attached and disconnected many times during the cleaning of a gun, the time savings can be substantial.

A threaded coupling connecting a handle to a cable does not allow cleaning implements to rotate. The quick connect t-handle disclosed herein allows the flex cable to spin, which allows the attached cleaning implements to spin as they follow the lands and grooves in the gun's bore. Other systems drag the cleaning implements across the lands and grooves, potentially missing fouling in the barrel.

### BRIEF SUMMARY OF THE INVENTION

The disclosed system is comprised of multiple gun cleaning components. These components can be combined to create gun cleaning kits or can be packaged as individual components. The system can be used to clean a wide variety of types and sizes of guns. The system includes a flexible cable for improved portability that attaches a t-handle to individual cleaning implements. In some embodiments, the system may include a fixed rigid rod instead of a flexible cable. The flexible cable is attached to the desired cleaning implement using a quick connect coupling and then is fed through the breech of a gun. Then the t-handle is attached to the opposite end of the flexible cable with a quick connect coupling. The cleaning implement is then pulled through the barrel of the gun. The t-handle is then removed using the quick connect coupling and the process is repeated.

Reference is made throughout the present disclosure to certain aspects of one embodiment of the gun cleaning system and its components described herein. Such references to aspects of the presently described system do not limit the scope of the claims attached hereto. Additionally, any examples set forth in this disclosure are not intended to be limiting and merely set forth some of the many possible embodiments for the appended claims. It is to be understood that the phraseology and terminology used herein are for the purpose of description and should not be regarded as limiting.

### BRIEF DESCRIPTION OF THE DRAWINGS

FIG. 1 is an exploded view of one embodiment of the disclosed portable gun cleaning system.

FIG. 2A is a bottom view of the exterior of the case of one embodiment of the disclosed system.

FIG. 2B is a front view of the exterior of the case of one embodiment of the disclosed system.

FIG. 2C is a top view of the exterior of the case of one embodiment of the disclosed system.

FIG. 2D is a side view of the exterior of the case of one embodiment of the disclosed system.

FIG. 2E is a back view of the exterior of the case of one embodiment of the disclosed system.

FIG. 2F is a top left front view of the exterior of the case of one embodiment of the disclosed system.

FIG. 3A is a top view of the interior of the case of one embodiment of the disclosed system showing the components of the system within the case.

FIG. 3B is a view of the interior of the case of one embodiment of the disclosed system showing the components of the system within the case.

FIG. 4A is a left front view of the disclosed t-handle according to one embodiment of the present invention.

FIG. 4B is a top view of the disclosed t-handle according to one embodiment of the present invention.

FIG. 4C is a side view of the disclosed t-handle according to one embodiment of the present invention.

FIG. 4D is a front view of the disclosed t-handle according to one embodiment of the present invention.

FIG. 5A is a left front view of one embodiment of the disclosed slotted jag cleaning implement.

FIG. 5B is a back view of one embodiment of the disclosed slotted jag cleaning implement.

FIG. 5C is a side view of one embodiment of the disclosed slotted jag cleaning implement.

FIG. 5D is a front view of one embodiment of the disclosed slotted jag cleaning implement.

FIG. 6 is an illustration of one example of the butterfly cleaning patch according to one embodiment of the present invention.

FIG. 7 is a diagram illustrating the method for attaching a cleaning patch to a slotted jag cleaning implement according to one embodiment of the present invention.

FIG. 8A is a left front view of one embodiment of the disclosed brush cleaning implement.

FIG. 8B is a back view of one embodiment of the disclosed brush cleaning implement.

FIG. 8C is a side view of one embodiment of the disclosed brush cleaning implement.

FIG. 8D is a front view of one embodiment of the disclosed brush cleaning implement.

FIG. 9A is a left front view of one embodiment of the disclosed mop cleaning implement.

FIG. 9B is a back view of one embodiment of the disclosed mop cleaning implement.

FIG. 9C is a side view of one embodiment of the disclosed mop cleaning implement.

FIG. 9D is a front view of one embodiment of the disclosed mop cleaning implement.

FIG. 10 illustrates one example of the process by which the male quick connect coupler is received by the female quick connect coupler, according to one embodiment of the present invention.

FIG. 11A is a left front view of one embodiment of the disclosed quick connect adapter.

FIG. 11B is a back view of one embodiment of the disclosed quick connect adapter.

FIG. 11C is a side view of one embodiment of the disclosed quick connect adapter.

FIG. 11D is a front view of one embodiment of the disclosed quick connect adapter.

FIG. 12A is an illustration of one example of the disclosed cable according to one embodiment of the present invention.

FIG. 12B depicts one example of the disclosed cable as it attaches the t-handle to a cleaning implement in one embodiment of the disclosed system.

### DETAILED DESCRIPTION OF THE INVENTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover applications or embodiments without departing from the spirit or scope of the claims attached hereto. Also, it is to be understood that the phraseology and terminology used herein are for the purpose of description and should not be regarded as limiting.

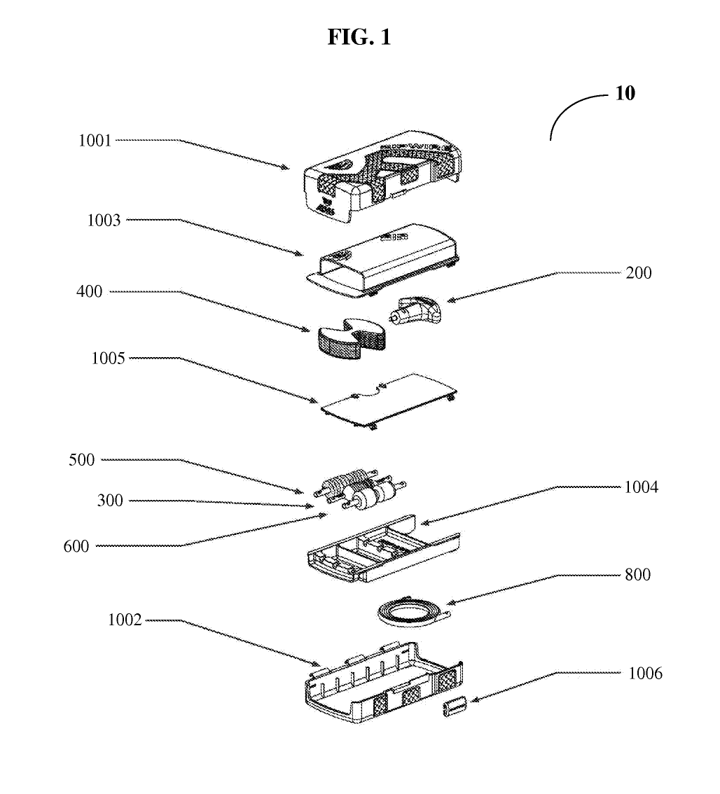

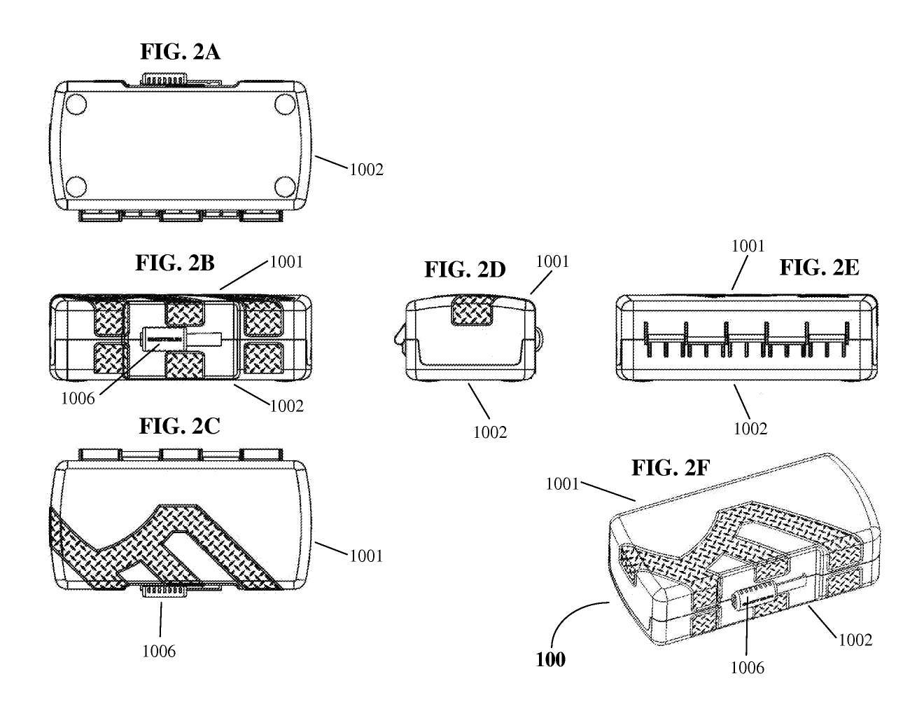

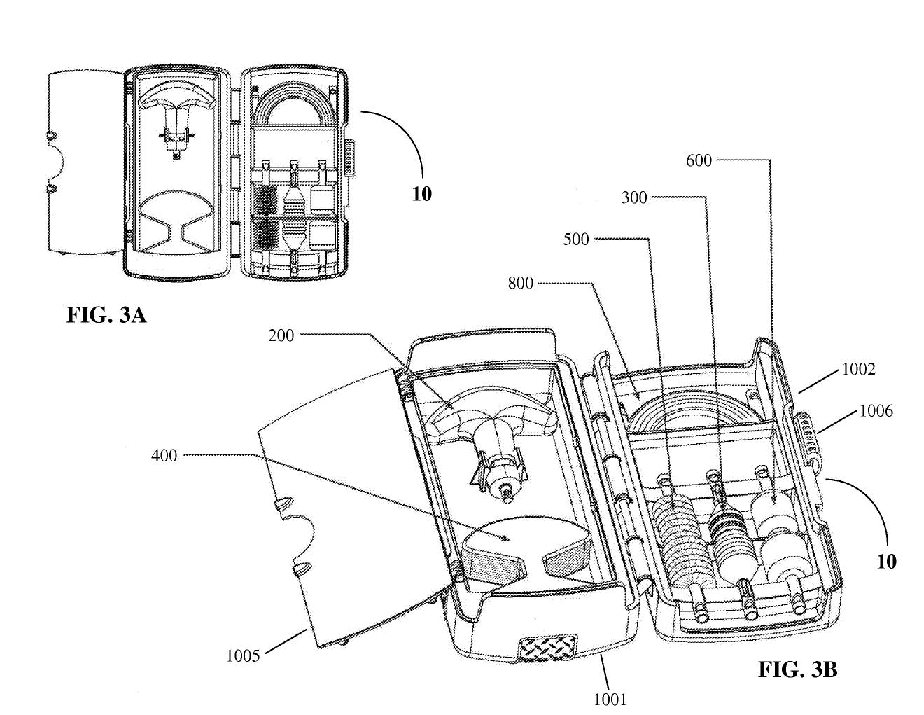

FIG. 1 is an exploded view of the presently disclosed gun cleaning system 10, illustrating the parts which comprise the case 100 and the various components of the system. As shown in FIG. 2A through 2F, the exterior of the case 100 may be comprised of a case top 1001, case bottom 1002, and slide lock 1006. FIG. 3A illustrates how the various components of the system 10 fit into the case 100 in one embodiment of the invention. FIG. 3B further illustrates an example of how the various components fit into the case 100. In this example, the case top 1001, which includes a top case insert 1003 (see FIG. 1), is configured to hold a t-handle 200 and a plurality of patches 400. The case top 1001 may further include a clear door 1005, configured to separate the components stored within case top 1001 from the components stored in case bottom 1002 when the case 100 is closed. Referring still to FIG. 3B, the case bottom 1002, which includes a bottom case insert 1004 (see FIG. 1), is configured in this example to hold a flexible cable 800, at least one brush 500, at least one slotted jag 300, and at least one mop 600. The example shown in FIG. 3B includes two of each of the brush 500, slotted jag 300, and mop 600. The case bottom 1002 may further comprise a slide lock 1006 which holds the case 100 closed.

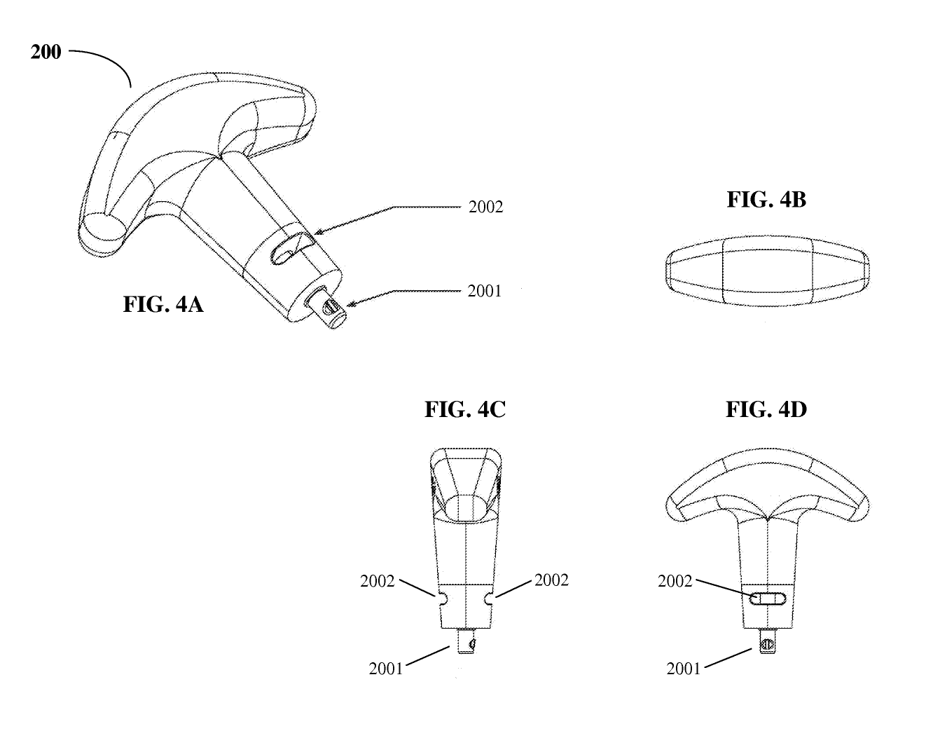

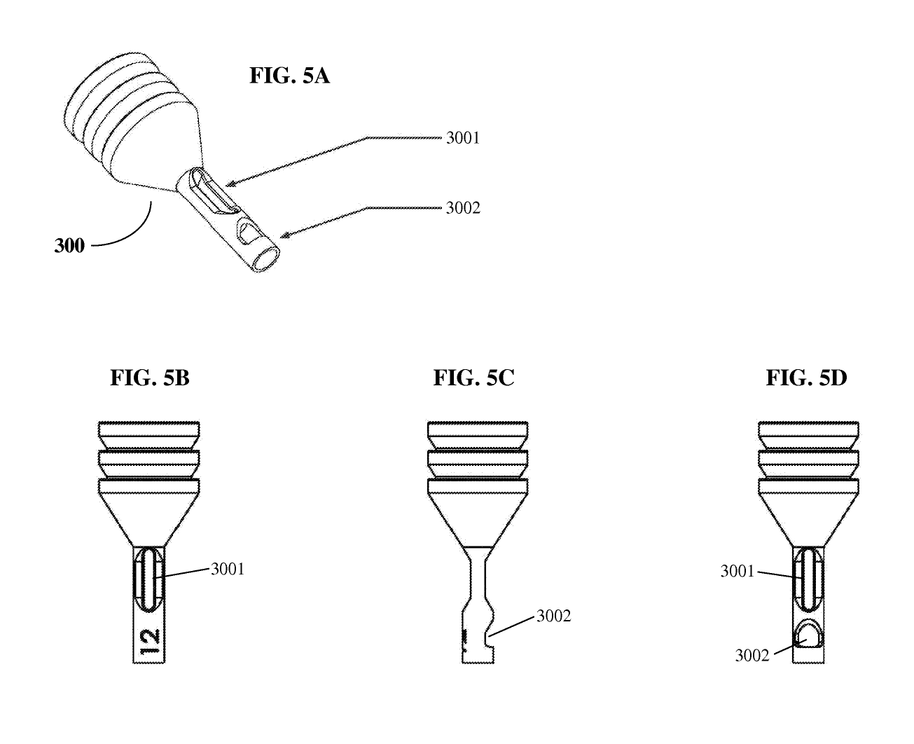

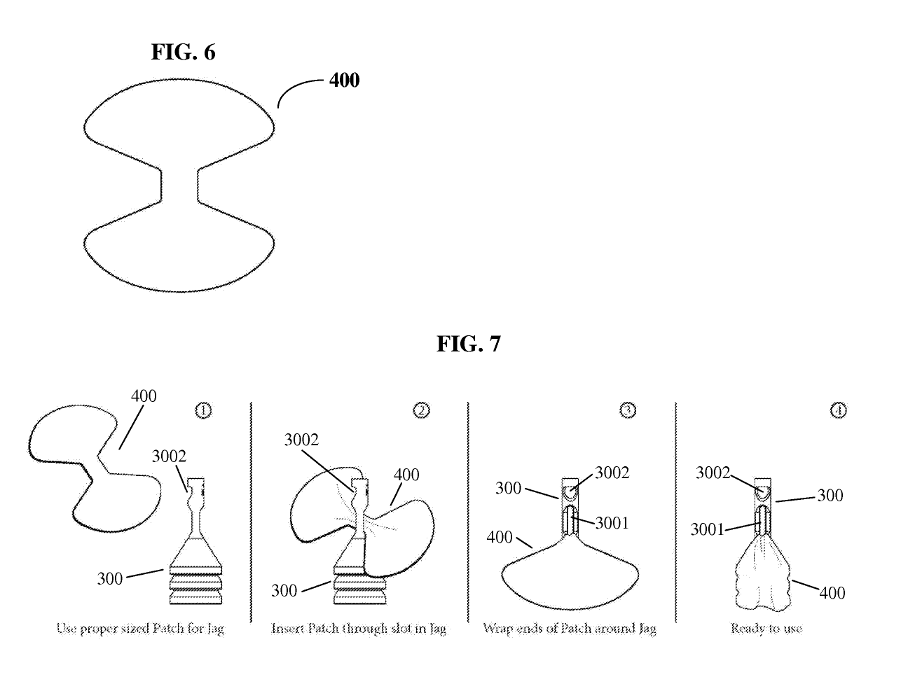

FIG. 4A through 4D consist of several views of the t-handle 200. The t-handle 200 includes a male quick connect coupler 2001 at one end, configured to connect with a female quick connect coupler as described later in this disclosure. The t-handle 200 further includes a mount 2002 which allows for rotation of the flex cable 800 (described below), allowing the brushes, jags, mops or other attached cleaning implements to spin as they follow the lands and grooves in the gun's bore. The presently disclosed system includes at least one slotted jag 300 that allows a user to use a jag with a flex cable system. An example of the slotted jag 300 is illustrated in FIG. 5A through 5D. The slotted jag 300 includes a female quick connect coupler 3002 at one end, configured to connect with a male quick connect coupler as described later in this disclosure. The slotted jag 300 further includes a slot 3001 configured to receive a cleaning patch 400, an example of which is depicted in FIG. 6. Traditional jags used with a fixed rod system are designed to be pushed through the bore of a gun. The disclosed system has a flexible rod or cable which works by pulling components through the bore. Traditionally, instead of a jag, flex cable systems utilize a slotted tip to pull cleaning patches through the bore. The slotted jag 300 provides far superior cleaning when compared to slotted tips. As illustrated in the diagram of FIG. 7, a cleaning patch 400 is inserted through the slot 3001 in the jag 300. The patch 400 is then wrapped around and covers the jag 300, which is fitted to the caliber of the bore being cleaned, providing a tight fit and constant friction as a user pulls the patch 400 through the bore of a gun. A slotted tip is not fitted to the caliber of the bore and relies on the bunching of the patch material to provide friction.

In the preferred embodiment, the disclosed system includes unique patches specifically designed to work with the slotted jag 300 disclosed herein. These patches provide superior and uniform coverage in the bore as they are pulled through. Traditional patches tend to be rectangular or circular shaped and bunch up as they wrap around a jag or slotted tip. FIG. 6 shows an example of the patch 400 described herein, which is a butterfly shape designed to fit perfectly around the disclosed slotted jag 300 as illustrated in the diagram of FIG. 7. The butterfly shape eliminates bunching and provides uniform contact through the entire length of the bore for a more thorough cleaning. In some embodiments, the butterfly-shaped patch may be replaced by any available cloth patch of any shape, such as rectangular or circular. The disclosed patch may be made of a brightly colored synthetic material to more clearly show dirt and to absorb better than traditional white cotton patches; any other woven cloth or material could be used for the patch.

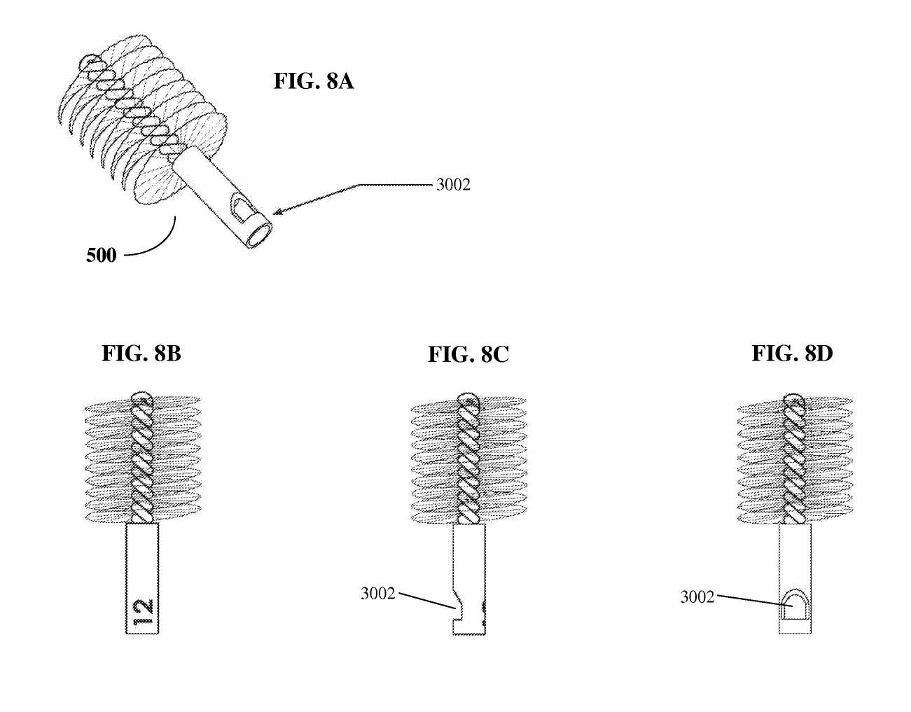

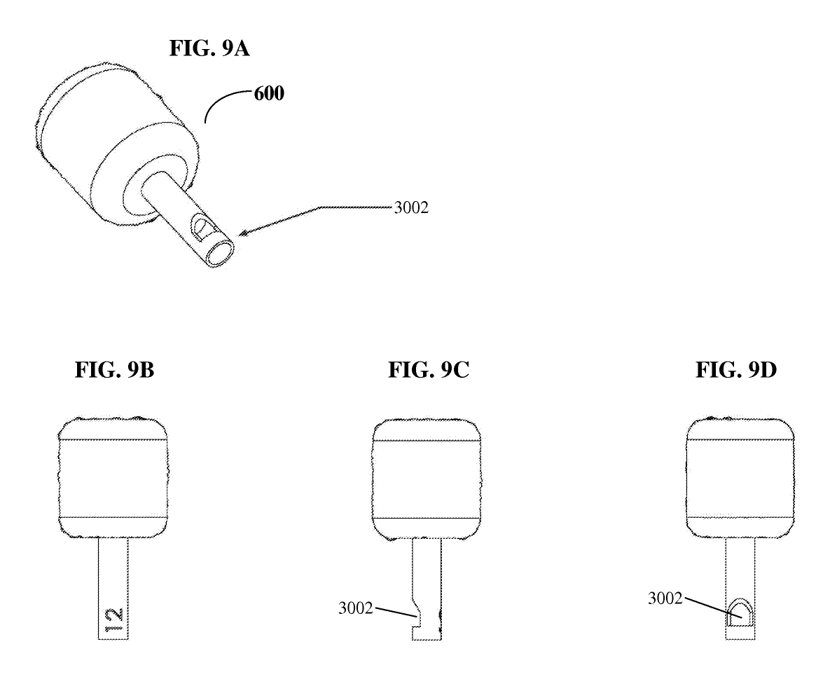

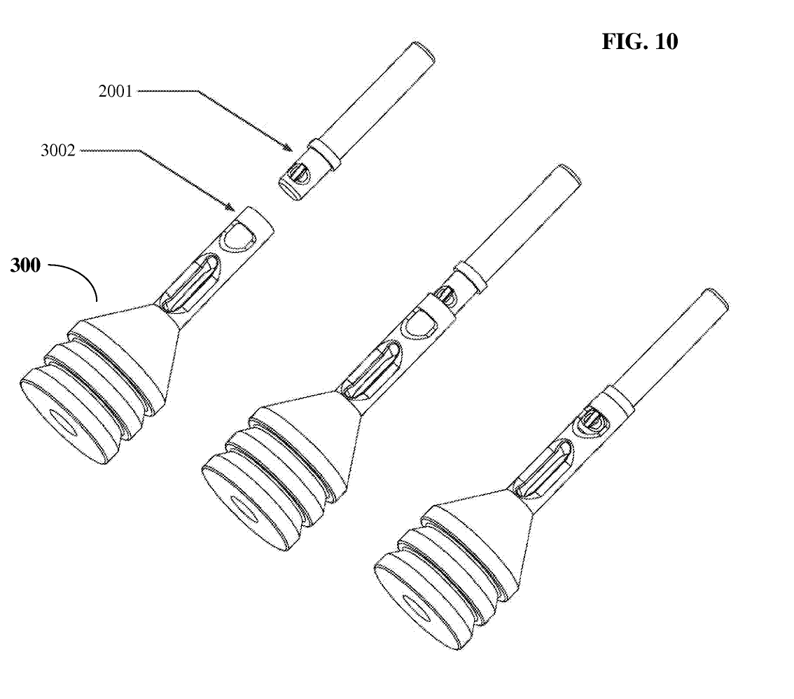

The system disclosed herein may include other cleaning implements, such as a brush, an example of which is illustrated in FIG. 8A through 8D, or a mop, an example of which is illustrated in FIG. 9A through 9D. Each cleaning implement included with the system 10 includes a female quick connect coupler 3002 at one end, configured to connect with a male quick connect coupler.

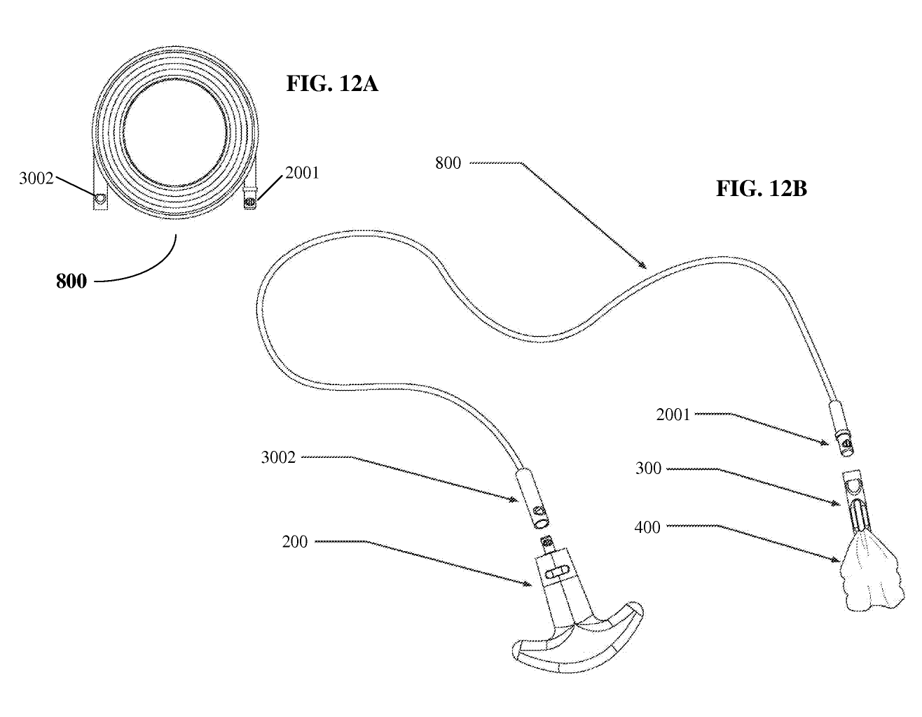

As illustrated in FIG. 10, each female quick connect coupler 3002 is configured to connect with a male quick connect coupler 2001. In the example illustrated in FIG. 10, the female quick connect coupler 3002 of the slotted jag 300 is shown receiving a male quick connect coupler 2001. The male quick connect coupler 2001 snaps into place when received by the female quick connect coupler 3002. The male quick connect coupler 2001 may be, for example, on one end of the cable 800, as depicted in FIG. 12A and 12B. FIG. 10 illustrates only one example of the cleaning implement which may use the quick connect method; a similar method may be used to connect any two of the disclosed system components which include a male quick connect coupler 2001 on one component and a female quick connect coupler on a second component. In some embodiments, the disclosed system may use a quick connect mechanism (male connector pin that fits into a female quick connect receiver), such as that disclosed in U.S. Pat. No. 6,872,039. In other embodiments, the system may use other connection means known in the art.

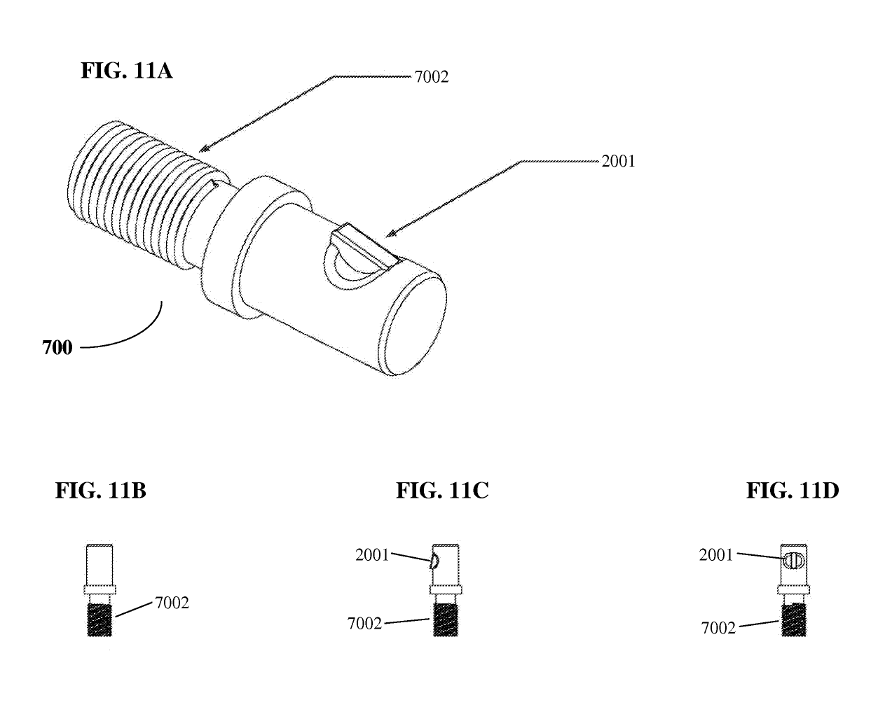

FIG. 11A through 11D illustrate an example quick connect adapter 700 which may be included with the system 10 or sold separately. The quick connect adapter 700 includes a male quick connect coupler 2001 on one end, configured to connect with a female quick connect coupler, and a threaded end 7002 which may be used to adapt to cleaning systems other than the system 10 disclosed herein.

FIG. 12A shows one example of the flexible cable 800 included in the system 10. The cable 800 includes a female quick connect coupler 3002 on the first end and a male quick connect coupler 2001 on the second end. In some embodiments, the flexible cable 800 may be replaced by a rigid or fixed rod, which may be made of metal or any other rigid material. FIG. 12B depicts one example of the cable 800 as it attaches the t-handle 200 to a cleaning implement in one embodiment of the disclosed system. In this example, the female quick connect coupler 3002 on the first end of the cable 800 receives the male quick connect coupler of the t-handle 200, using the method illustrated in FIG. 10. The male quick connect coupler 2001 on the second end of the cable 800 is received by the female quick connect coupler of the slotted jag 300 (which in this example is covered by the patch 400) using the method illustrated in FIG. 10. FIG. 12B shows only one example of the cleaning implements which may be connected to the cable 800 using the quick connect method of FIG. 10.

The disclosed system may combine components to create different portable gun cleaning kits (i.e. rifle cleaning kit, pistol cleaning kit, shotgun cleaning kit, AR-15 cleaning kit, etc.). Components of the system 10 may also be packaged independently or in small bundles. For example, slotted jags and brushes may be paired for different caliber guns and sold together. A person could buy a quick connect adapter 700, a slotted jag 300 and a brush 500 and then use these components with a cleaning kit as disclosed herein or with any other cleaning kit. Many different components will be sold separately or combined in different combinations.

For a better understanding of the present disclosure, its advantages, and the specified objects attained by its uses, reference should be made to the accompanying drawings and descriptive matter in which there are illustrated exemplary embodiments of the present disclosure. The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A cleaning system comprising:
A flexible cable having a first end and a second end, wherein the first end comprises a connection means for a handle to attach to the first end and the second end comprises a connection means for a cleaning implement to attach to the second end;
A handle configured to attach to the first end of the flexible cable; and
A cleaning implement configured to attach to the second end of the flexible cable.

2. The cleaning system of claim 1, wherein the cleaning implement is a slotted jag configured to hold a cleaning patch.

3. The cleaning system of claim 2, wherein the cleaning patch is butterfly shaped.

4. The cleaning system of claim 3, wherein the cleaning patch is a cloth patch.

5. The cleaning system of claim 1, wherein the cleaning implement is a slotted tip configured to hold a cleaning patch.

6. The cleaning system of claim 1, wherein the cleaning implement is a brush.

7. The cleaning system of claim 1, wherein the cleaning implement is a mop.

8. The cleaning system of claim 1, wherein the handle is a T-shaped handle.

9. The cleaning system of claim 1, wherein the flexible cable is comprised of metal.

10. The cleaning system of claim 1, wherein the flexible cable is capable of being coiled and straightened repeatedly without breaking.

11. The cleaning system of claim 1, wherein the connection means is a quick connect.

12. A cleaning system comprising:
A fixed rod having a first end and a second end, wherein the first end comprises a connection means for a handle to attach to the first end and the second end comprises a connection means for a cleaning implement to attach to the second end;
A handle configured to attach to the first end of the fixed rod; and
A cleaning implement configured to attach to the second end of the fixed rod.

13. The cleaning system of claim 12, wherein the cleaning implement is a slotted jag configured to hold a cleaning patch.

14. The cleaning system of claim 13, wherein the cleaning patch is butterfly shaped.

15. The cleaning system of claim 14, wherein the cleaning patch is a cloth patch.

16. The cleaning system of claim 12, wherein the cleaning implement is a slotted tip configured to hold a cleaning patch.

17. The cleaning system of claim 12, wherein the cleaning implement is a brush.

18. The cleaning system of claim 12, wherein the cleaning implement is a mop.

19. The cleaning system of claim 12, wherein the handle is a T-shaped handle.

20. The cleaning system of claim 12, wherein the connection means is a quick connect.
